(19) United States
(12) Patent Application Publication
(10) Pub. No.: US 2026/0001486 A1
(43) Pub. Date: Jan. 1, 2026

(54) METHOD FOR CORRECTING SET-UP ERROR OF CAMERAS INSTALLED OUTSIDE OF THE VEHICLE

(71) Applicant: Cheol Jin PARK, Gyeonggi-do (KR)

(72) Inventors: Cheol Jin PARK, Gyeonggi-do (KR); Won In BAEK, Gyeonggi-do (KR)

(21) Appl. No.: 19/251,964

(22) Filed: Jun. 27, 2025

(30) Foreign Application Priority Data
Jun. 28, 2024 (KR) 10-2024-0085239

(51) Int. Cl. B60R 1/27

(52) U.S. Cl. CPC B60R 1/27; B60R 2300/105; B60R 2300/303; B60R 2300/304; B60R 2300/306; B60R 2300/402; B60R 2300/607

(57) ABSTRACT

A method of correcting an arrangement error of a plurality of cameras installed outside a vehicle according to an embodiment of the present disclosure includes executing a camera's position error correction application to correct position errors of a plurality of cameras, the vehicle correcting camera position information preset to the reference camera position to the actual position of a plurality of cameras, and the vehicle correcting the camera position information to the actual position of a plurality of cameras, and then terminating the camera position error correction app.

### CROSS REFERENCE TO RELATED APPLICATION

The present application claims priority to and the benefit of Korean Patent Application 10-2024-0085239, filed on Jun. 28, 2024, the entire contents of which are hereby incorporated by reference.

### BACKGROUND OF THE INVENTION

The present disclosure relates to a method of correcting an arrangement error from a reference point of a plurality of cameras installed in a vehicle.

### DESCRIPTION OF TH RELATED ART

The automobile industry has recently undergone major technological changes. The concept of mobility is expanding from simple vehicle operation to new technologies and services that integrate various means of transportation.

In particular, autonomous driving technology plays a big role in improving fuel efficiency, preventing driver negligence accidents, and changing the concept to multipurpose mobility. Domestic startups and SMEs are also investing in the field of autonomous driving, and lightweight technology for improving fuel efficiency is also an important topic.

There are also technological advances in the railway system. Data communication, including video calls, is possible on trains running at a speed of 350 km or more, and a 4G railway integrated wireless network is used to transmit train control data of the Korean train control system.

Technology trends in the automotive industry are constantly changing, and more innovation and development are expected.

Camera position error correction refers to the process of accurately adjusting or calibrating a measuring device or system of a road or road. This calibration is a necessary task to accurately obtain measurement results.

For example, checking and adjusting the accuracy of automobile speedometers also corresponds to camera position error correction. Calibration is an important step to maintain high accuracy and reliability.

### SUMMARY

The purpose of this disclosure is to accurately correct installation errors of plurality of cameras installed outside a vehicle, especially in blind spots, such as a low-speed trailer performing road calibration to solve the problems of the prior art described above.

In the method of correcting the arrangement error of a plurality of cameras installed outside the vehicle according to an embodiment of the present disclosure, the vehicle may include executing a camera position error correction application to correct the position error of the plurality of cameras; the vehicle correcting camera position information preset to the reference camera position to the actual position of the plurality of cameras; and the vehicle may terminate the camera position error correction application after correcting the camera position information to the actual position of the plurality of cameras.

In addition, the vehicle may further include correcting the camera angle information set to the reference camera angle to the actual angle of the plurality of cameras.

In addition, the vehicle may include a step of monitoring the camera position error correction situation.

In addition, the vehicle may include displaying a screen for setting a speed limit option for setting the camera position error correction progress.

In addition, the vehicle may include setting a speed limit option or releasing a speed limit setting according to a user's selection.

In addition, when the user selects the Road-cal Mode #Full button, the vehicle's front ROI among plurality of ROIs formed by the plurality of cameras may include stopping monitoring.

In addition, the vehicle may include correcting the position or angle of the left and right cameras and the rear cameras among the plurality of cameras that photograph the rear ROI among the plurality of ROIs.

According to the present disclosure, even if plurality of cameras installed outside the vehicle, such as trailers, are not accurately located during road driving, it is possible to easily correct errors from the reference position of cameras while driving at low speeds without stopping the vehicle.

In addition, according to the present disclosure, it is possible to further improve the accuracy of road calibration of a vehicle traveling on a road.

### BRIEF DESCRIPTION OF THE DRAWINGS

FIG. 1 illustrates a flowchart illustrating a method of correcting an arrangement error of a plurality of cameras installed outside a vehicle according to an embodiment of the present invention.

FIG. 2 illustrates a vehicle and a plurality of cameras according to an embodiment of the present invention.

FIG. 3 illustrates an example of a camera position error correction app screen displayed on a tablet screen.

FIG. 4 illustrates another example of a camera position error correction app screen displayed on a tablet screen.

FIG. 5 illustrates another example of a camera position error correction app screen displayed on a tablet screen.

FIG. 6 is a screen illustrating a speed limit option selected by a user.

FIG. 7 illustrates a surround view screen by a general camera.

FIG. 8, FIG. 9, FIG. 10, FIG. 11, FIG. 12 and FIG. 13 illustrate surround view screens after camera position error correction according to an embodiment of the present invention.

### DETAILED DESCRIPTION

### Explanation Of Terms in This Specification

All embodiments described below are exemplarily shown to aid understanding of the present disclosure and may be modified differently from the embodiments described herein to be implemented in various embodiments. In addition, in describing the present disclosure, if it is determined that a detailed description of a related known function or known component may unnecessarily obscure the gist of the present disclosure, the detailed description thereof will be omitted.

To help understand the disclosure, the attached drawings are not shown at the actual scale, but the dimensions of some components may be exaggerated, and when reference numbers are written on each component, the same components are marked with the same code as possible even if they are shown in different drawings.

In addition, terms such as first, second, A, B, (a) and (b) may be used to describe components of embodiments of the present disclosure. These terms are only intended to distinguish the components from other components, and the nature, order, or the like of the corresponding components is not limited by the terms. If a component is stated to be ‘connected’, ‘combined’, or ‘connected’ to another component, that component may be directly connected, coupled, or connected to that other component, but it should be understood that another component may be ‘connected’, ‘combined’ or ‘connected’ between that component and that other component.

Therefore, since the configurations shown in the embodiments and drawings described herein are only the most preferred embodiments of the present disclosure and do not represent all of the technical ideas of the present disclosure, there may be various modified embodiments of the present disclosure.

In addition, terms or words used in this specification and claims should not be limited to ordinary or dictionary meanings, and should be interpreted as meanings and concepts consistent with the technical idea of this disclosure based on the principle that the inventor can properly define the concept of the term to describe his or her disclosure in the best way.

In addition, the singular expression used in this application includes a plurality of expressions unless it means something clearly different in the context.

### [Flow Flowchart of how to Correct Camera Placement Errors]

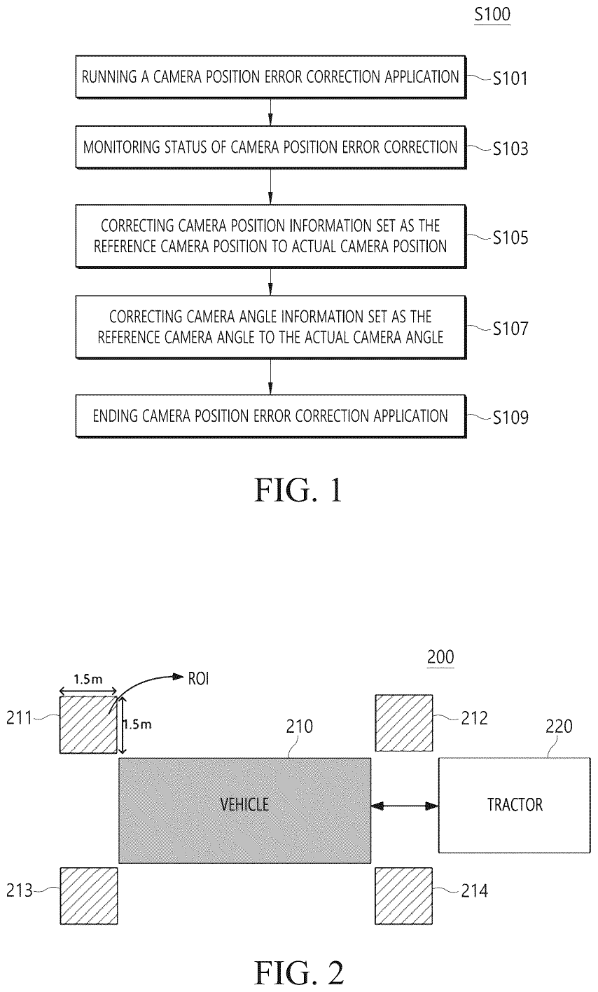

FIG. 1 illustates a flowchart illustrating a method of correcting an arrangement error of a plurality of cameras installed outside a vehicle according to an embodiment of the present invention.

As shown in FIG. 1, the camera arrangement error correction method (S100) according to an embodiment of the present invention includes steps S101, S103, S105, S107, and S109, and a detailed description thereof is as follows.

First, a vehicle according to an embodiment of the present invention executes a position error correction application of a camera (S101).

Subsequently, the vehicle according to the embodiment of the present invention monitors the camera position error correction situation (S103).

Next, the vehicle according to an embodiment of the present invention corrects camera position information set as the reference camera position to the actual position of the camera (S105).

Subsequently, the vehicle according to an embodiment of the present invention corrects camera angle information set to the reference camera angle to the actual angle of the camera (S107).

Next, the vehicle according to the embodiment of the present invention terminates the camera position error correction app after the camera position/angle correction is completed (S109).

### [the Purpose of the Camera Placement Error Correction Method]

The camera placement error correction method according to an embodiment of the present disclosure is intended to allow plurality of cameras (e.g., HT Link Vue camera) mounted on the vehicle's trailer to check the surround view around the vehicle, and to correct plurality of cameras even when they are out of the reference installation position. In addition, even if there is insufficient space or time for calibration after installing the cameras, errors in camera installation can be automatically corrected while the trailer (vehicle) is driving.

### [Explanation on Camera Installation Error]

The cameras must be installed in compliance with the set standards. The types of errors and the limit error ranges that may occur when the camera is installed are shown in Table 1 below.

TABLE 1

| | | LIMIT ERROR | |
|---|---|---|---|
| CATEGORY | CONTENT | RANGE | |
| X | X value of 3D coordinates ofr camera | ±5 | mm |
| Y | Y value of 3D coordinates ofr camera | ±5 | mm |
| Z | Z value of 3D coordinates ofr camera | ±5 | mm |
| Yaw | Pan angle of the camera | ±1 | degree |
| Roll | Tilt angle of the camera | ±1 | degree |
| Pitch | Rotation angle of the camera | ±2 | degree |

### [Conditions for Camera Installation Error Correction (Road Calibration)]

The following shows a condition for correcting a camera installation error according to an embodiment of the present disclosure.
1) The initial setting value of the plurality of cameras should be set according to the camera installation specification and the trailer (vehicle specification).
2) The camera installation error shall be within the margin of error shown in Table 1.
3) Prior to calibration, the stitching error of the SVM must be within 1 m.
4) The distance between the tractor in front of the vehicle and the vehicle (trailer) shall be wide.

FIG. 2 illustrates a vehicle and a plurality of cameras according to an embodiment of the present invention.

As shown in FIG. 2, the four corners of the vehicle 210 are ROI areas 211, 212, 213, and 214.

The vehicle continuously checks the stitching state of the road surface in the ROI area during the camera position error correction.

When the distance between the tractor 220 and the vehicle 210 in front of the vehicle is narrow or there is an obstacle such as a Ripper, the ROI view at the front edge may not be secured. In this case, it is difficult to perform camera position error correction (Road Calibration) by referring to all four corners, and there is an alternative to giving up correcting the front cameras 212 and 214 and only correcting the left camera, the right camera, and the rear camera.

### [Road Calibration Time]

When data for checking the stitching state is secured in the ROI area of FIG. 2, the camera position error correction is terminated within a plurality of minutes.

However, it may take longer to obtain the ROI data. For example, if the shadow of the vehicle 210 is hung short near the noon time, ROI data may be secured more easily.

In addition, better ROI data may be obtained when the vehicle's shadow gradually moves in four directions and casts over a wider range.

In addition, better ROI data may be obtained if the road surface's sign is a curve (e.g., in the form of a curved figure) rather than a clear and simple straight line.

### [Optional Road Calibration Setting]

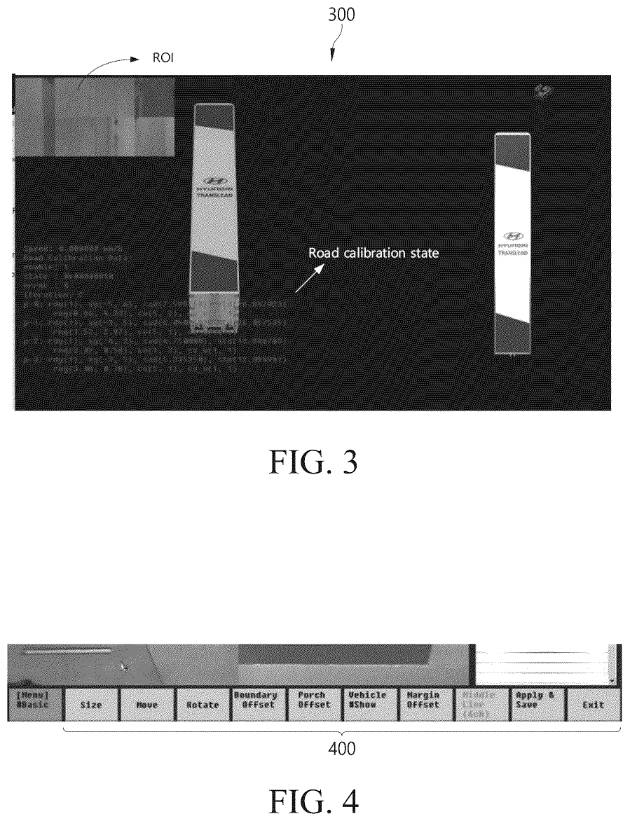

FIG. 3 illustrates an example of a camera position error correction app screen displayed on a tablet screen.

FIG. 4 illustrates another example of a camera position error correction app screen displayed on a tablet screen.

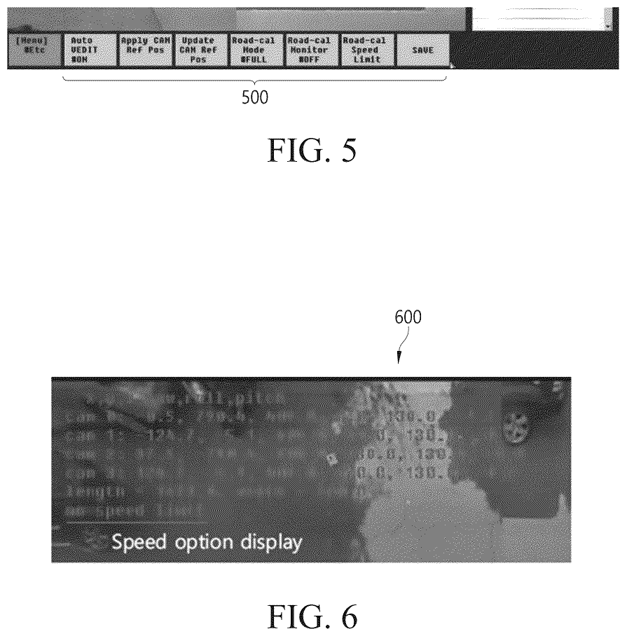

FIG. 5 illustrates another example of a camera position error correction app screen displayed on a tablet screen.

### 1) Start the Camera Position Error Correction (Road Calibration)

In the tablet app of FIG. 4 or 5, when you enter the Road Calibration menu, activate Road Calibration, and come back out, Road Calibration starts, and when Road Calibration ends, it automatically shuts down.
In the same manner as in FIG. 4 or 5, the monitor directly connected to the ECU enters the Road Calibration menu, activates the Road Calibration, and starts the Road Calibration even when it comes out again.
During Road Calibration, a vehicle-shaped icon is displayed in the upper right corner of the screen.

### 2) End of Camera Position Error Correction (Road Calibration)

To forcibly terminate the camera position error correction, enter the Road Calibration menu in the tablet app of FIG. 4 or 5 to deactivate the Road Calibration and exit again.
When the monitor directly connected to the ECU of FIG. 4 or 5 enters the Road Calibration menu, deactivates Road Calibration, and comes out again, the camera position error correction is forcibly terminated.

### 3) Monitoring the Camera Position Error (Road Calibration)

If you want to check the ROI and state on the screen as follows during the camera position error correction of FIG. 4 or 5, turn on the camera position error monitoring in the POST calibration menu of the ECU of FIG. 4 or 5.

For example, if you select the [Menu] #Basic button three times (e.g., click) in the Post Calibration menu of FIG. 4 or FIG. 5, the [Menu] #Etc menu is displayed.

For example, if it is Rod-cal Monitor #OFF in FIG. 4 or 5, the camera position error correction monitoring screen is not displayed, and if it is #ON, the monitoring screen is displayed. When the above-described button of FIG. 4 or 5 is selected (e.g., clicked), #ON and #OFF are switched.

If the SAVE button of FIG. 4 or 5 is selected, the application of the corresponding setting may be stored.

### 4) Restoring to Reference Camera Position/Angle

To restore camera position/angle information to the camera reference installation position/angle calculated by the specifications of the vehicle and the camera position, select the “Apply CAM Ref Pos” button of FIG. 4 or 5.

The current camera-based installation position/angle is defined as shown in Table 2 below.

TABLE 2

| | X | Y | Z | YAW | ROLL | PITCH |
|---|---|---|---|---|---|---|
| CAM-1 | 0 | 811.5 | 409 | 0 | 130 | 0 |
| CAM-2 | −134 | 0 | 409 | 90 | 130 | 0 |
| CAM-3 | 38 | −811.5 | 408 | 180 | 130 | 0 |
| CAM-4 | 134 | 0 | 409 | 270 | 130 | 0 |

### 5) Speed Limit Options

It can be regarded as valid ROI data only when it becomes a GPS lock and the velocity (speed) is less than or equal to the reference value.

The vehicle has the option of 10 km/s, 20 km/h, 30 km/h, or no speed check.

For example, if the option (no speed limit) is selected, ROI data is captured regardless of GPS lock or not. Here, if the user selects the “Road-cal Speed Limit” button, the setting is changed to the order of 10 km/s, 20 km/s, 30 km/h, and No speed limit.

FIG. 6 illustrates a screen illustrating a speed limit option selected by a user.

As illustrated in FIG. 6, the selected option may be displayed on a left upper end as illustrated in FIG. 6.

### 6) Trailer and Tractor Gaps are Narrow

When the user selects the “Road-cal Mode #Full” button, it is switched to “Road-cal Mode #REAR”.

Give up the forward ROI and attempt to adjust the left and rear cameras with the rear ROI alone.

### [Camera Location Error Correction Scenario]

If the camera position error correction state is stored and loaded when the vehicle is driven again, the camera position error correction is automatically executed.

### [Test Result]

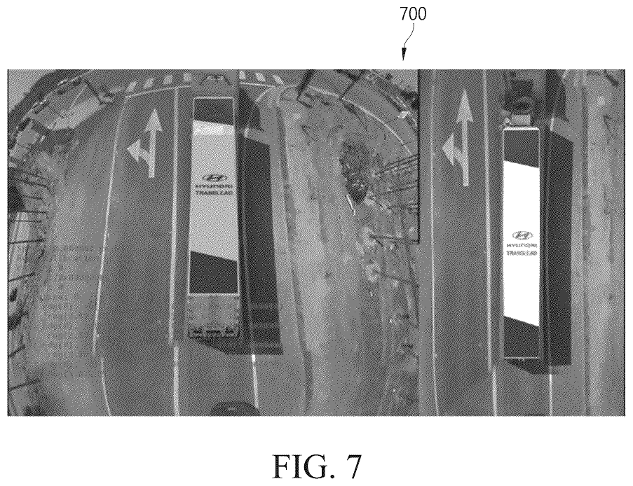

FIG. 7 illustrates a surround view screen by a general camera.

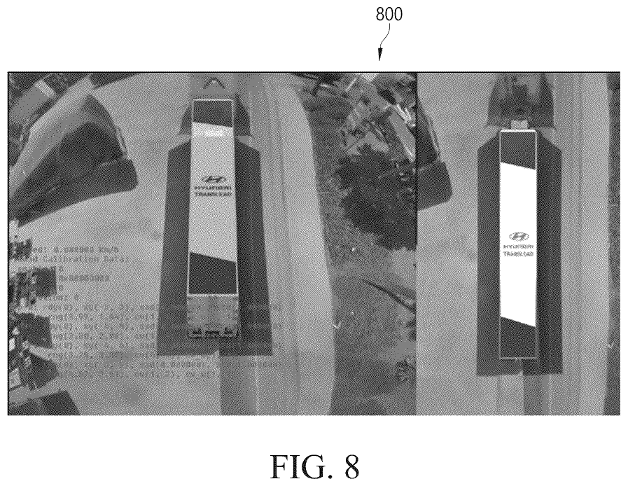

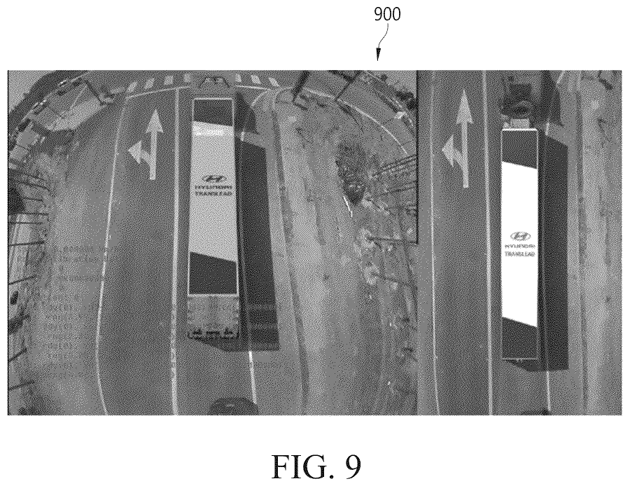

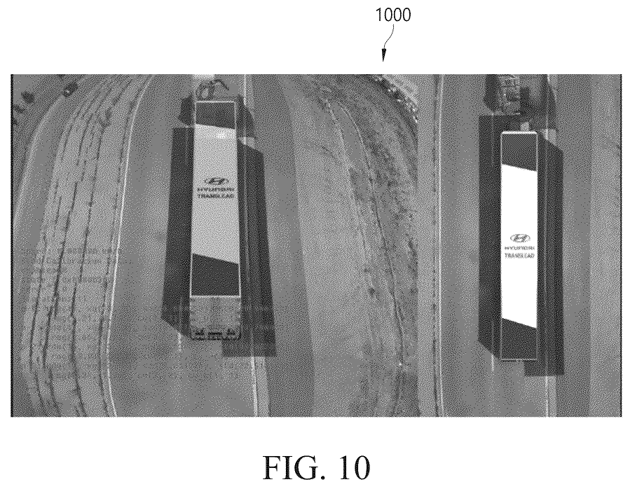

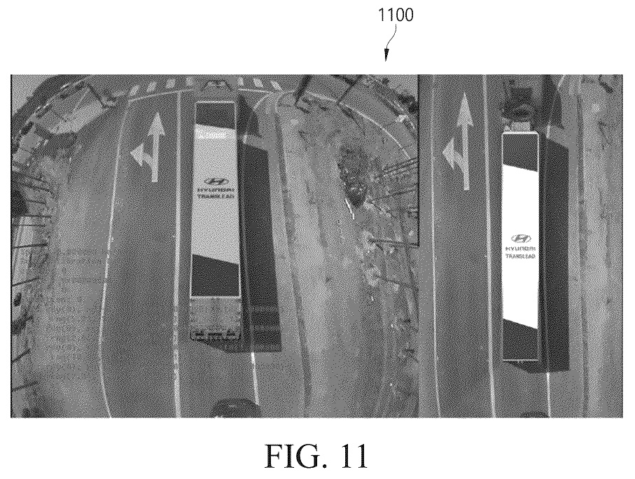

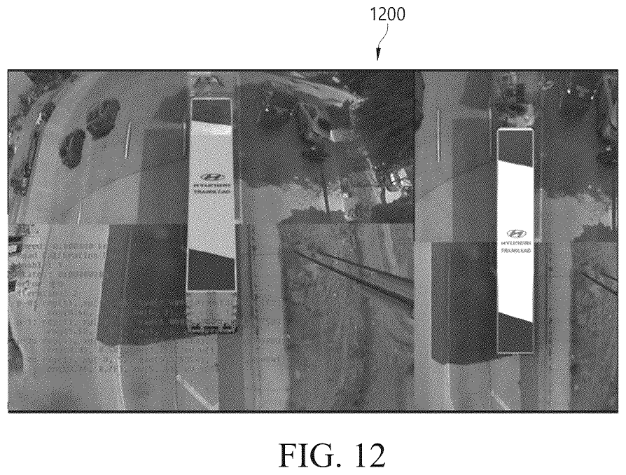

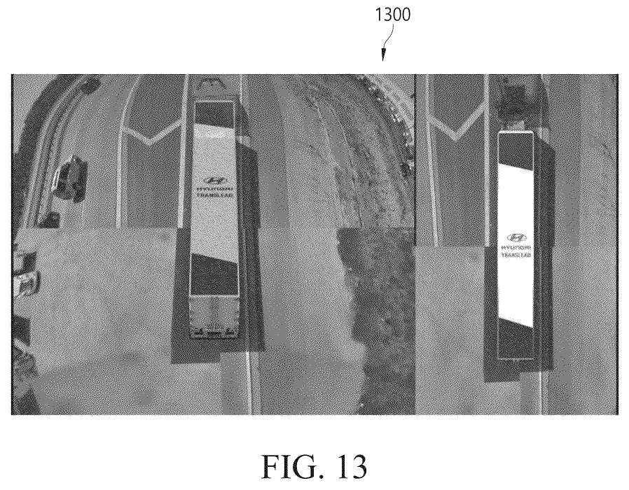

FIG. 8, FIG. 9, FIG. 10, FIG. 11, FIG. 12 and FIG. 13 illustrate surround view screens after camera position error correction according to an embodiment of the present invention.

When the surround view screen shown in FIG. 7 and the surround view screen after camera position correction of the present invention shown in FIG. 8, FIG. 9, FIG. 10, FIG. 11, FIG. 12 and FIG. 13, it may be confirmed that the surround view screen after camera position correction shown in FIG. 8, FIG. 9, FIG. 10, FIG. 11, FIG. 12 and FIG. 13 represents a more accurate surround view screen.

Specifically, in the ROI area of each of the four corners around the vehicle, the operation of checking the state of each ROI and storing the result data may be performed independently of each of the four corners.

In addition, the optimal data for camera position error correction (Road Calibration) for each ROI area of the four corners can be data (e.g., image data) obtained at different times (or time zones or time zones).

FIG. 8, FIG. 10, FIG. 12 and FIG. 13 show data on four ROI areas acquired by photographing at different times (or time zones or time zones).

[how to Interpret this Specification]

Although the embodiments of the present disclosure have been described in more detail with reference to the accompanying drawings, the present disclosure is not limited to this embodiment and may be variously modified without departing from the technical idea of the present disclosure.

Therefore, the embodiments disclosed in the present disclosure are intended to illustrate and not limit the technical idea of the present disclosure, and the scope of the technical idea of the present disclosure is not limited by this embodiment. Therefore, it should be understood that the embodiments described above are illustrative in all respects and are not limited. The scope of protection of the present disclosure should be interpreted by the following claims, and all technical ideas within the equivalent scope should be construed as being included in the scope of the present disclosure.

What is claimed is:

1. A method of correcting the placement error of plurality of cameras installed outside the vehicle of the vehicle, comprising:
executing, by the vehicle a camera's position error correction application to correct position errors of the plurality of cameras;
correcting, by the vehicle, camera position information preset to the reference camera position to the actual position of the plurality of cameras; and
ending, by the vehicle, the camera position error correction app after the vehicle corrects the camera position information to the actual position of the plurality of cameras.

2. The method of claim 1, further comprising:
correcting, by the vehicle, the camera angle information set to the reference camera angle to the actual angle of the plurality of cameras.

3. The method of claim 2, comprising:
monitoring, by the vehicle, the camera position error correction situation.

4. The method of claim 1, comprising:
displaying, by the vehicle, a screen for setting a speed limit option for setting the camera position error correction progress.

5. The method of claim 4, comprising:
setting, by the vehicle, a speed limit option or releasing a speed limit setting according to a user's selection.

6. The method of claim 1, comprising:
when the user selects the ROI number selecting button (Road-cal Mode #Full button), stopping, by the vehicle, monitoring front ROI among the plurality of ROIs formed by the plurality of cameras.

7. The method of claim 6, comprising:
correcting, by the vehicle, the position or angle of the left and right cameras and the rear cameras of the plurality of cameras that photograph the rear ROI among the plurality of ROIs.
